(19) United States
(12) Patent Application Publication
(10) Pub. No.: US 2023/0177241 A1
(43) Pub. Date: Jun. 8, 2023

(54) METHOD FOR DETERMINING SIMILAR SCENARIOS, TRAINING METHOD, AND TRAINING CONTROLLER

(71) Applicant: dSPACE GmbH, Paderborn (DE)

(72) Inventors: Daniel HASENKLEVER, Paderborn (DE); Sven BURDORF, Paderborn (DE); Christian NOLDE, Paderborn (DE); Harisankar MADHUSUDANAN NAIR SHEELA, Paderborn (DE)

(73) Assignee: dSPACE GmbH, Paderborn (DE)

(21) Appl. No.: 18/075,791

(22) Filed: Dec. 6, 2022

(30) Foreign Application Priority Data
Dec. 6, 2021 (DE) 10 2021 132 025.9
Dec. 6, 2021 (EP) 21212482.0

(51) Int. Cl. G06F 30/27

(52) U.S. Cl. CPC G06F 30/27

(57) ABSTRACT

A computer-implemented method for providing a machine learning algorithm for determining similar scenarios based on scenario data of a data set of sensor data, wherein an optimization algorithm is applied to the feature representation, output by the first machine learning algorithm, of the first augmentation of the data set of sensor data, wherein the optimization algorithm approximates the feature representation, output by the second machine learning algorithm, of the second augmentation of the data set of sensor data. The invention further relates to a method for determining similar scenarios based on scenario data of a data set of sensor data and to a training controller.

This nonprovisional application claims priority under 35 U.S.C. § 119(a) to German Patent Application No. 10 2021 132 025.9, which was filed in Germany on Dec. 6, 2021, and to European Patent Application No. 21212482.0, which was filed in Europe on Dec. 6, 2021, and which are both herein incorporated by reference.

### BACKGROUND OF THE INVENTION

### Field of the Invention

The present invention relates to a computer-implemented method for providing a machine learning algorithm for determining similar scenarios based on scenario data of a data set of sensor data.

The present invention further relates to a computer-implemented method for determining similar scenarios based on scenario data of a data set of sensor data.

Furthermore, the invention relates to a training controller for providing a machine learning algorithm for determining similar scenarios based on scenario data of a data set of sensor data.

### Description of the Background Art

Driving assistance systems such as, e.g., adaptive cruise control and/or functions for highly automated driving can be verified or validated using various verification methods. Simulations in particular can be used in this regard.

Test drives must be carried out to create test scenarios for simulations. The sensor data obtained in this way are then abstracted into a logical scenario.

Input data here are raw data, therefore, sensor data from real test drives in the sense of recordings of radar echoes, 3D point clouds from lidar measurements, and image data. Result data are simulatable driving scenarios, which comprise an environment on the one hand and trajectories on the other hand. This is followed by a categorization of driving maneuvers into groups.

“Szenario-Optimierung für die Absicherung von automatisierten und autonomen Fahrsystemen” [Scenario Optimization for the Validation of Automated and Autonomous Driving Systems] (Florian Hauer, B. Holzmüller, 2019) discloses methods for verifying and validating automated and autonomous driving systems, in particular finding suitable test scenarios for virtual validation.

The test methodology foresees the adoption of a metaheuristic search to optimize scenarios. For this purpose, a suitable search space and a suitable fitness function need to be created. Parameterized scenarios are derived starting from an abstract description of the system’s functionality and use cases.

Their parameters span a search space from which the appropriate scenarios are to be identified. However, generating scenarios is computationally intensive. There is interest therefore in minimizing the number of generation operations and limiting them to relevant scenarios. Relevant scenarios comprise, for example, scenarios that are not yet available or not available in sufficient numbers as a simulatable scenario.

Consequently, there is a need to improve existing methods for determining similar scenarios based on scenario data of a data set of sensor data to enable identification of relevant scenarios using fewer computational resources.

### SUMMARY OF THE INVENTION

It is therefore an object of the present invention to provide a more efficient method for determining similar scenarios based on scenario data of a data set of sensor data.

According to an exemplary embodiment of the invention, the object is achieved by a computer-implemented method for providing a machine learning algorithm for determining similar scenarios based on scenario data of a data set of sensor data.

The object is further achieved by a computer-implemented method for determining similar scenarios based on scenario data of a data set of sensor data.

Also, the object is further achieved by a training controller for providing a machine learning algorithm for determining similar scenarios based on scenario data of a data set of sensor data.

Moreover, the object is achieved by a computer program with a program code to perform the method of the invention when the computer program is executed on a computer.

The invention relates to a computer-implemented method for providing a machine learning algorithm for determining similar scenarios based on scenario data of a data set of sensor data.

The method comprises providing the data set of sensor data of a drive, captured by a plurality of on-board environment detection sensors, by an ego vehicle and generating a first augmentation of the data set of sensor data and a second augmentation, different from the first augmentation, of the data set of sensor data. In general the term “ego vehicle” can represent a virtual vehicle in the center of a simulation or a test. E.g. the vehicle for that a new function is to be developed or tested. Typically, one skilled in the art uses such to distinguish a central vehicle (“ego”) from other vehicles or traffic participants (pedestrians, bicycles, etc. ) that are usually called “fellows” or “fellow vehicles” that appear in a simulation or test and can interact or have an impact on the ego.

Furthermore, the method comprises applying a first machine learning algorithm to the first augmentation of the data set of sensor data for generating an in particular dimension-reduced feature representation of the first augmentation of the data set of sensor data and for determining a first class of a scenario covered by the first augmentation of the data set of sensor data.

Moreover, the method comprises applying a second machine learning algorithm to the second augmentation of the data set of sensor data for generating an in particular dimension-reduced feature representation of the second augmentation of the data set of sensor data and for determining a second class of a scenario covered by the second augmentation of the data set of sensor data.

The method further comprises applying an optimization algorithm to the feature representation of the first augmentation, output by the first machine learning algorithm, of the data set of sensor data, wherein the optimization algorithm approximates the feature representation, output by the second machine learning algorithm, of the second augmentation of the data set of sensor data.

The invention further relates to a computer-implemented method for determining similar scenarios based on scenario data of a data set of sensor data.

The method comprises providing the data set of sensor data of a drive, captured by a plurality of on-board environment detection sensors, by an ego vehicle and applying the machine learning algorithm trained according to the invention to the data set of sensor data for determining, in particular clustering, similar scenarios.

The invention relates moreover to a training controller for providing a machine learning algorithm for determining similar scenarios based on scenario data of a data set of sensor data.

The training controller has a receiver for receiving the data set of sensor data of a drive, captured by a plurality of on-board environment detection sensors, by an ego vehicle and a generator for generating a first augmentation of the data set of sensor data and a second augmentation, different from the first augmentation, of the data set of sensor data.

Furthermore, the training controller can apply a first machine learning algorithm to the first augmentation of the data set of sensor data for generating an in particular a dimension-reduced feature representation of the first augmentation of the data set of sensor data and for determining a first class of a scenario covered by the first augmentation of the data set of sensor data.

The training controller also can apply a second machine learning algorithm to the second augmentation of the data set of sensor data for generating an in particular a dimension-reduced feature representation of the second augmentation of the data set of sensor data and for determining a second class of a scenario covered by the second augmentation of the data set of sensor data.

Additionally, the training controller can apply an optimization algorithm to the feature representation, output by the first machine learning algorithm, of the first augmentation of the data set of sensor data, wherein the optimization algorithm approximates the feature representation, output by the second machine learning algorithm, of the second augmentation of the data set of sensor data.

The invention further relates to a computer program with a program code to perform the method of the invention when the computer program is executed on a computer.

One idea of the present invention is to solve the problem of identifying similar maneuver/interaction maneuver clusters from trajectories and map data in a sequential data set using machine learning algorithms.

In particular, map data can be used by machine learning algorithms to learn feature representations of trajectories and map data.

This learned feature representation can be used by a clustering algorithm to group the trajectory features based on different maneuvers. For example, this can use the trajectory features of the ego vehicle and those of a nearby object in order to group scenarios based on the interaction maneuver.

In this case, the machine learning algorithms learn representation features of the interaction maneuver from the trajectory of the ego vehicle, the trajectory of the object with which the ego vehicle interacts, and the road information either as map data or encoded in vehicle trajectories in a self-monitored manner.

The trained model is then used to generate feature vector representations of interaction maneuvers from an unknown (test) data set. The generated feature vectors are later used for clustering similar interaction maneuvers.

A first augmentation is created, which is transferred to the first machine learning algorithm, and a second augmentation of the input data is created, which is transferred to the second machine learning algorithm. The encoders or coders encode the information into low-dimensional feature vectors.

A similarity loss, which is to be minimized during training, is calculated for the outputs of the two networks. This forces the encoders to learn important features that can distinguish similar interaction maneuvers.

The trained encoders can be used to generate feature vectors for all trajectories representing interaction maneuvers in the data set. These in turn can be clustered by a clustering algorithm, such as, e.g., hierarchical clustering, to form interaction groups in the data set.

Machine learning algorithms may be based on the fact that statistical methods are used to train a data processing system such that it can perform a specific task without originally being explicitly programmed to do so. The goal of machine learning here is to construct algorithms that can learn from data and make predictions. These algorithms create mathematical models with which, for example, data can be classified.

The skilled artisan understands a dimension-reduced feature representation to be the transformation of data from a high-dimensional space to a low-dimensional space, so that the low-dimensional representation retains some meaningful properties of the original data, ideally close to its intrinsic dimension.

A similarity loss between the first class, output by the first machine learning algorithm, of the scenario covered by the first augmentation of the data set of sensor data, and the second class, output by the second machine learning algorithm, of the scenario, covered by the second augmentation of the data set of sensor data, can be minimized by the optimization algorithm. This forces the encoders to learn features that can distinguish similar interaction maneuvers.

The first machine learning algorithm can have a first encoder, which receives trajectory and/or speed data of the ego vehicle of the first augmentation of the data set of sensor data, a second encoder, which receives trajectory, speed, and/or class ID data of at least one object of the first augmentation of the data set of sensor data, and a third encoder, which receives road information of the first augmentation of the data set of sensor data. Thus, a dimension-reduced feature representation of the first augmentation of the data set of sensor data can be generated in an advantageous manner.

The second machine learning algorithm can have a fourth encoder, which receives trajectory and/or speed data of the ego vehicle of the second augmentation of the data set of sensor data, a fifth encoder, which receives trajectory, speed, and/or class ID data of at least one object of the second augmentation of the data set of sensor data, and a sixth encoder, which receives road information of the second augmentation of the data set of sensor data. Thus, a dimension-reduced feature representation of the second augmentation of the data set of sensor data can be generated in an advantageous manner.

The first encoder, the second encoder, and the third encoder can each output a feature vector, which are concatenated into a first feature vector, and wherein the fourth encoder, the fifth encoder, and the sixth encoder each output a feature vector, which are concatenated into a second feature vector. Thus, a combined representation of all input data of the respective encoder networks can be generated in an advantageous manner.

The first machine learning algorithm can determine the first class of the scenario covered by the first augmentation of the data set of sensor data using the concatenated first feature vector, and wherein the second machine learning algorithm determines the second class of the scenario covered by the second augmentation of the data set of sensor data using the concatenated second feature vector. Thus, a combined representation of all input data of the respective encoder networks can be generated in an advantageous manner.

According to an example, it is provided that the first to sixth encoders can have LSTM (Long Short-Term memory) layers.

LSTM layers are advantageously more suitable for trajectory data as opposed to 2D convolutional layers for image data. The map information can be provided to the respective encoder network either explicitly or implicitly as coded information together with the trajectories.

Trajectory data, covered by the data set of sensor data, of the ego vehicle and/or of the object each can have a different feature size depending on a number of time steps in which the object is located within a detection range of the plurality of on-board environment detection sensors.

Thus, in an advantageous manner, a time duration during which the ego vehicle and/or the object is located within the detection range of the plurality of on-board environment detection sensors can be expressed in a different feature representation in each case.

The first machine learning algorithm and the second machine learning algorithm can use ragged tensors to process the trajectory data, covered by the data set of sensor data, of the ego vehicle and/or the object.

The feature size of trajectories depends on the number of time steps during which the object was within the range of the ego vehicle sensors. Because this duration can be influenced by many factors, each trajectory and the associated map information have a different feature size, which must be taken into account. This requires the use of ragged tensors (tensors with a different number of elements in each dimension).

The first augmentation and the second augmentation for creating different variants of the data set of sensor data may be randomly generated. In this way, effective coverage of a state space comprising the parameters of the respective data sets can be achieved in an advantageous manner.

The scenarios can have driving maneuvers of the ego vehicle and/or a fellow vehicle and/or interaction maneuvers of the ego vehicle with the fellow vehicle and/or further objects.

The trained encoders can thus be used to generate feature vectors for all trajectories representing interaction maneuvers in the data set. These can be clustered by a clustering algorithm, such as, e.g., hierarchical clustering, to form interaction groups in the data set.

The trajectory and/or speed data of the ego vehicle can be captured by a GPS sensor, and wherein the trajectory, speed, and/or class ID data of the at least one object, as well as road information, can be captured by a camera sensor, LiDAR sensor, and/or radar sensor.

The machine learning algorithms thus advantageously process data from different types of sensors to generate similar scenarios based on the scenario data of the data set of sensor data.

The features, described herein, of the method for providing a machine learning algorithm for determining similar scenarios based on scenario data of a data set of sensor data are equally applicable to the method of the invention for determining similar scenarios based on scenario data of a data set of sensor data and/or the training controller, and vice versa.

### Brief Description of the Drawings

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

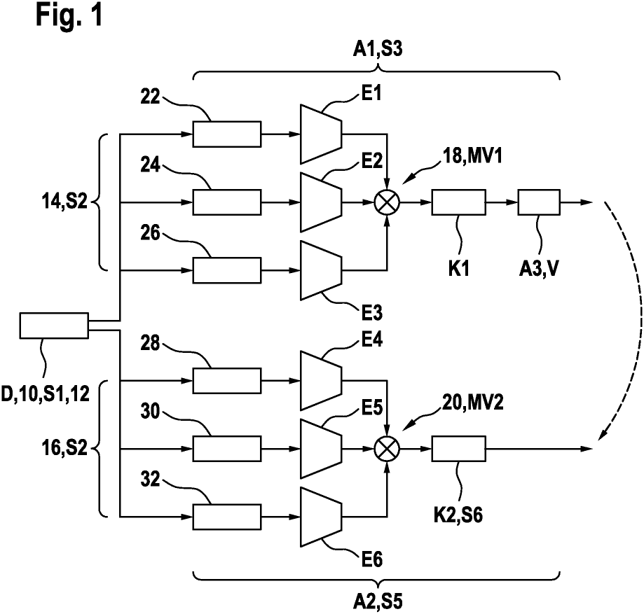

FIG. 1 shows a flowchart of a computer-implemented method for providing a machine learning algorithm for determining similar scenarios based on scenario data of a data set of sensor data according to an example of the invention;

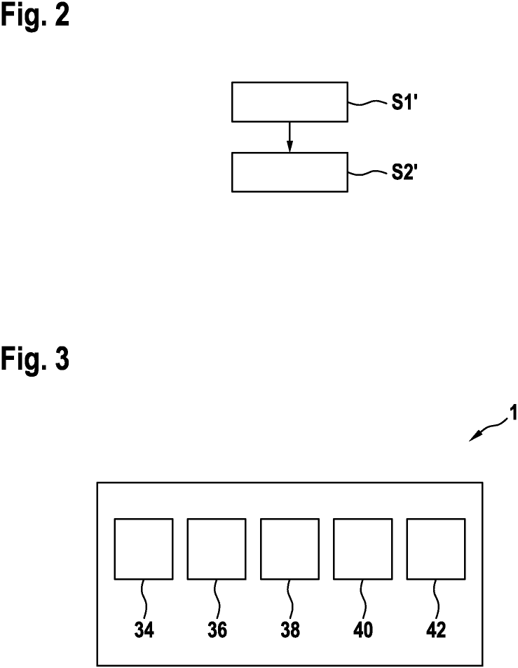

FIG. 2 shows a flowchart of a method for determining similar scenarios based on scenario data of a data set of sensor data according to an example of the invention; and

FIG. 3 shows a training controller for providing a machine learning algorithm for determining similar scenarios based on scenario data of a data set of sensor data according to an example of the invention.

### DETAILED DESCRIPTION

The method shown in FIG. 1 for providing a machine learning algorithm for determining similar scenarios based on scenario data of a data set D of sensor data comprises providing S1 the data set D of sensor data of a drive, captured by a plurality of on-board environment detection sensors 10, by an ego vehicle 12.

The method further comprises generating S2 a first augmentation 14 of the data set D of sensor data and a second augmentation 16, different from the first augmentation 14, of the data set D of sensor data and applying S3 a first machine learning algorithm A1 to the first augmentation 14 of the data set D of sensor data for generating an in particular dimension-reduced feature representation 18 of first augmentation 14 of the data set D of sensor data and for determining a first class K1 of a scenario covered by first augmentation 14 of the data set D of sensor data.

The method further comprises applying S5 a second machine learning algorithm A2 to second augmentation 16 of the data set D of sensor data for generating an in particular dimension-reduced feature representation 20 of second augmentation 16 of the data set D of sensor data and for determining S6 a second class K2 of a scenario covered by second augmentation 16 of the data set D of sensor data.

Moreover, the method comprises applying an optimization algorithm A3 to the feature representation 18, output by the first machine learning algorithm A1, of the first augmentation 14 of the data set D of sensor data, wherein optimization algorithm A3 approximates the feature representation 20, output by second machine learning algorithm A2, of second augmentation 16 of the data set D of sensor data.

Furthermore, a similarity loss V between the first class K1, output by first machine learning algorithm A1, of the scenario, covered by first augmentation 14 of the data set D of sensor data, and the second class K2, output by second machine learning algorithm A2, of the scenario, covered by second augmentation 16 of the data set D of sensor data, is minimized by optimization algorithm A3.

First machine learning algorithm A1 has a first encoder E1 that receives trajectory and/or speed data 22 of ego vehicle 12 of first augmentation 14 of the data set D of sensor data.

Further, first machine learning algorithm A1 has a second encoder E2 that receives trajectory, speed, and/or class ID data 24 of at least one object of the first augmentation 14 of the data set D of sensor data.

Moreover, first machine learning algorithm A1 has a third encoder E3 that receives road information 26 of first augmentation 14 of the data set D of sensor data.

Second machine learning algorithm A2 has a fourth encoder E4 that receives trajectory and/or speed data 28 of ego vehicle 12 of second augmentation 16 of the data set D of sensor data.

Further, second machine learning algorithm A2 has a fifth encoder E5 that receives trajectory, speed, and/or class ID data 30 of at least one object of second augmentation 16 of the data set D of sensor data.

Moreover, second machine learning algorithm A2 has a sixth encoder E6 that receives road information 32 of second augmentation 16 of the data set D of sensor data.

First encoder E1, second encoder E2, and third encoder E3 each output a feature vector, which are concatenated into a first feature vector MV1. Fourth encoder E4, fifth encoder E5, and sixth encoder E6 each also output a feature vector, which are concatenated into a second feature vector MV2.

First machine learning algorithm A1 determines the first class K1 of the scenario, covered by first augmentation 14 of the data set D of sensor data, using the concatenated first feature vector MV1. Second machine learning algorithm A2 determines the second class K2 of the scenario, covered by second augmentation 16 of the data set D of sensor data, using the concatenated second feature vector MV2. The first to sixth encoders E 1-E6 further have LSTM layers.

Trajectory data 22, 28, covered by the data set D of sensor data, of ego vehicle 12 and/or the object each have a different feature quantity depending on a number of time steps in which the object is within a detection range of the plurality of on-board environment detection sensors 10.

First machine learning algorithm A1 and second machine learning algorithm A2 further use ragged tensors for processing the trajectory data 22, 28, covered by the data set D of sensor data, of ego vehicle 12 and/or the object. First augmentation 14 and second augmentation 16 for creating different variants of the data set D of sensor data are thereby randomly generated.

The scenarios have driving maneuvers of ego vehicle 12 and/or a fellow vehicle and/or interaction maneuvers of ego vehicle 12 with the fellow vehicle and/or other objects.

The trajectory and/or speed data 22, 28 of ego vehicle 12 are captured by a GPS sensor. The trajectory, speed, and/or class ID data 24, 30 of the at least one object, as well as the road information, are captured by a camera sensor, LiDAR sensor, and/or radar sensor.

FIG. 2 shows a flowchart of a method for determining similar scenarios based on scenario data of a data set of sensor data according to the preferred embodiment of the invention.

The method comprises providing S1′ the data set D of sensor data of a drive, captured by a plurality of on-board environment detection sensors 10, by an ego vehicle 12 and applying S2′ a machine learning algorithm, trained according to the invention, to the data set D of sensor data for determining, in particular clustering, similar scenarios.

FIG. 3 shows a training controller 1 for providing a machine learning algorithm for determining similar scenarios based on scenario data of a data set of sensor data according to the preferred embodiment of the invention.

Training controller 1 comprises a receiver 34 for receiving the data set D of sensor data of a drive, captured by a plurality of on-board environment detection sensors 10, by an ego vehicle 12 and a generator 36 for generating a first augmentation 14 of the data set D of sensor data and a second augmentation 16, different from the first augmentation 14, of the data set D of sensor data.

Furthermore, training controller 1 has an applicator 38 for applying a first machine learning algorithm A1 to first augmentation 14 of the data set D of sensor data for generating an in particular dimension-reduced feature representation 18 of first augmentation 14 of the data set D of sensor data and for determining a first class K1 of a scenario covered by first augmentation 14 of the data set D of sensor data.

Training controller 1 further comprises a second applicator 40 for applying a second machine learning algorithm A2 to second augmentation 16 of the data set D of sensor data for generating an in particular a dimension-reduced feature representation 20 of second augmentation 16 of the data set D of sensor data and for determining a second class K2 of a scenario covered by second augmentation 16 of the data set D of sensor data.

Moreover, training controller 1 has a third applicator 42 for applying an optimization algorithm A3 to feature representation 18, output by first machine learning algorithm A1, of first augmentation 14 of the data set D of sensor data, wherein the optimization algorithm A3 approximates the feature representation 20, output by the second machine learning algorithm A2, of the second augmentation 16 of the data set D of sensor data.

The applicators may be software and/or hardware that are used in training an AI-algorithm, for example a personal computer, workstations or part of a cloud infrastructure. It can include a software that can be used in training process of an AI-algorithm and typically comprises one or more processing units, such as central processing units (CPU) or graphics processing unit (GPU).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method to provide a machine learning algorithm to determine similar scenarios based on scenario data of a data set of sensor data, the method comprising:
providing the data set of sensor data of a drive, captured by a plurality of on-board environment detection sensors, by a vehicle;
generating a first augmentation of the data set of sensor data and a second augmentation that is different from the first augmentation of the data set of sensor data;
applying a first machine learning algorithm to the first augmentation of the data set of sensor data for generating a dimension-reduced feature representation of the first augmentation of the data set of sensor data and for determining a first class of a scenario covered by the first augmentation of the data set of sensor data;
applying a second machine learning algorithm to the second augmentation of the data set of sensor data for generating an in particular dimension-reduced feature representation of the second augmentation of the data set of sensor data and for determining a second class of a scenario covered by the second augmentation of the data set of sensor data; and
applying an optimization algorithm to the feature representation output by the first machine learning algorithm of the first augmentation of the data set of sensor data, the optimization algorithm approximating the feature representation output by the second machine learning algorithm of the second augmentation of the data set of sensor data.

2. The computer-implemented method according to claim 1, wherein a similarity loss between the first class output by the first machine learning algorithm of the scenario covered by the first augmentation of the data set of sensor data and the second class output by the second machine learning algorithm of the scenario covered by the second augmentation of the data set of sensor data, is minimized by the optimization algorithm.

3. The computer-implemented method according to claim 1, wherein the first machine learning algorithm has a first encoder, which receives trajectory and/or speed data of the vehicle of the first augmentation of the data set of sensor data, a second encoder, which receives trajectory, speed, and/or class ID data of at least one object of the first augmentation of the data set of sensor data, and a third encoder, which receives road information of the first augmentation of the data set of sensor data.

4. The computer-implemented method according to claim 1, wherein the second machine learning algorithm has a fourth encoder, which receives trajectory and/or speed data of the vehicle of the second augmentation of the data set of sensor data, a fifth encoder, which receives trajectory, speed, and/or class ID data of at least one object of the second augmentation of the data set of sensor data, and a sixth encoder, which receives road information of the second augmentation of the data set of sensor data.

5. The computer-implemented method according to claim 3, wherein the first encoder, the second encoder, and the third encoder each output a feature vector, which are concatenated into a first feature vector, and wherein the fourth encoder, the fifth encoder, and the sixth encoder each output a feature vector, which are concatenated into a second feature vector.

6. The computer-implemented method according to claim 5, wherein the first machine learning algorithm determines the first class of the scenario, covered by the first augmentation of the data set of sensor data, using the concatenated first feature vector, and wherein the second machine learning algorithm determines the second class of the scenario, covered by the second augmentation of the data set of sensor data, using the concatenated second feature vector.

7. The computer-implemented method according to claim 1, wherein the first to sixth encoders have LSTM layers.

8. The computer-implemented method according to claim 3, wherein trajectory data, covered by the data set of sensor data of the vehicle and/or of the object each have a different feature size depending on a number of time steps in which the object is located within a detection range of the plurality of on-board environment detection sensors.

9. The computer-implemented method according to claim 8, wherein the first machine learning algorithm and the second machine learning algorithm use ragged tensors to process the trajectory data covered by the data set of sensor data of the vehicle and/or the object.

10. The computer-implemented method according to claim 1, wherein the first augmentation and the second augmentation for creating different variants of the data set of sensor data are randomly generated.

11. The computer-implemented method according to claim 1, wherein the scenarios have driving maneuvers of the vehicle and/or a fellow vehicle and/or interaction maneuvers of the vehicle with the fellow vehicle and/or further objects.

12. The computer-implemented method according to claim 3, wherein the trajectory and/or speed data of the vehicle are captured by a GPS sensor, and wherein the trajectory, speed, and/or class ID data of the at least one object and the road information are captured by a camera sensor, LiDAR sensor, and/or radar sensor.

13. A computer-implemented method to determine similar scenarios based on scenario data of a data set of sensor data, the method comprising:
providing the data set of sensor data of a drive, captured by a plurality of on-board environment detection sensors, by a vehicle; and
applying a machine learning algorithm trained according to claim 1 to the data set of sensor data for determining clustering similar scenarios.

14. A training controller to provide a machine learning algorithm to determine similar scenarios based on scenario data of a data set of sensor data, the training controller comprising:
a receiver to receive the data set of sensor data of a drive captured by a plurality of on-board environment detection sensors by a vehicle;
a generator to generate a first augmentation of the data set of sensor data and a second augmentation, different from the first augmentation, of the data set of sensor data;
a first applicator to apply a first machine learning algorithm to the first augmentation of the data set of sensor data for generating an in particular dimension-reduced feature representation of the first augmentation of the data set of sensor data and to determine a first class of a scenario covered by the first augmentation of the data set of sensor data;
a second applicator to apply a second machine learning algorithm to the second augmentation of the data set of sensor data for generating a dimension-reduced feature representation of the second augmentation of the data set of sensor data and to determine a second class of a scenario covered by the second augmentation of the data set of sensor data; and
a third applicator to apply an optimization algorithm to the feature representation output by the first machine learning algorithm of the first augmentation of the data set of sensor data,
wherein the optimization algorithm approximates the feature representation output by the second machine learning algorithm of the second augmentation of the data set of sensor data.

15. A computer program with a program code to perform the method according to claim 1, when the computer program is executed on a computer.
